(19) United States
(12) Patent Application Publication
(10) Pub. No.: US 2025/0276364 A1
(43) Pub. Date: Sep. 4, 2025

(54) MOLD RELEASE OF MICROWAVE SINTERED LUNAR REGOLITH

(71) Applicant: Blue Origin Manufacturing, LLC, Huntsville, AL (US)

(72) Inventors: Vernon G. Harris, II, Los Angeles, CA (US); Lauren Thomas Sagan, Los Angeles, CA (US)

(21) Appl. No.: 18/592,771

(22) Filed: Mar. 1, 2024

(51) Int. Cl. B22F 3/105; B22F 3/00; B64G 99/00

(52) U.S. Cl. CPC B22F 3/105; B22F 3/004; B22F 2003/1054; B22F 2201/20; B22F 2302/25; B64G 99/00

(57) ABSTRACT

Methods and systems are presented for sintering a material, which may be in a granulated or powdered form, in a mold using microwave radiation. These methods and systems may lead to a sintered object that contracts (e.g., shrinks) away from sides of the mold so that it is able to be easily released from the mold. Accordingly, for example, sides of the mold need not be angled (e.g., with draft angles), which is generally done to molds to allow for the molded object to be releasable, such as by lifting or dumping out the molded part. A particular advantage of these methods and systems, besides not needing to distort a mold shape with draft angles, is that the contraction caused by microwave sintering may likely avoid chemical reactions or adhesion between the sides of the mold and the sintered object because the contraction causes a gap therebetween.

### BACKGROUND

Some of the key challenges of lunar colonization and other activities on the Moon are the cost and logistics of transporting materials from Earth to the Moon. To overcome this, scientists and engineers have been exploring the concept of in-situ resource utilization (ISRU), which involves using materials found on the moon to build infrastructure, produce fuel, and sustain life.

The moon's surface, or regolith, is rich in resources such as iron, aluminum, silicon, and oxygen. These materials may be extracted and processed to construct various things such as habitats, structures, solar panels, manufacturing equipment, and so on. Accordingly, research continues to concentrate on techniques for utilizing lunar resources.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic cross-section side view of a granular material in a mold prepared for microwave sintering, according to some embodiments.

FIG. 2 is a schematic cross-section side view of granular material in a mold that has been sintered and contracted from the sides of the mold, according to some embodiments.

FIG. 3 is a schematic cross-section side view of granular material that has been melted and solidified in a mold, according to some embodiments.

FIG. 4 is a graph of a microwave energy absorption coefficient as a function of temperature for an example material, according to some embodiments.

FIG. 5 is a schematic cross-section side view of a granular material that includes microwave susceptors and in a mold prepared for microwave sintering, according to some embodiments.

FIG. 6 is a flow diagram of a process for microwave sintering a material in a mold, according to some embodiments.

### DETAILED DESCRIPTION

This disclosure describes, among other things, systems and methods for sintering a material, which may be in a granulated or powdered form, in a mold using microwave radiation. These systems and methods may lead to a sintered object (e.g., sintered granulated material) that contracts (e.g., shrinks) away from sides of the mold so that it is able to be easily released from the mold. Accordingly, for example, sides of the mold need not be angled (e.g., with draft angles), which is generally done to molds to allow for the molded object to be releasable, such as by lifting or dumping out the molded part. A particular advantage of these systems and methods, besides not needing to distort a mold shape with draft angles, is that the contraction caused by microwave sintering may likely avoid chemical reactions or adhesion between the sides of the mold and the sintered object because the contraction causes a gap therebetween. For example, in various implementations, microwave-sintered objects may be used as a structural building material on the Moon. Thus, the granulated material that is microwave-sintered is lunar regolith, which generally includes many different chemical compounds. It may be possible that at least one or more of these compounds may react with inside surfaces of a mold, particularly near or above the melting temperature of lunar regolith. Chemical reactions may result in chemical bonding of the molded material to the mold or chemical erosion of the mold surfaces, leading to the degradation or destruction of the mold. However, contraction of sintered material away from at least some of the mold surfaces may allow for the avoidance of chemical reactions.

In some embodiments, a method of microwave sintering a material in a mold includes at least partially filling the mold with the material, irradiating the material in the mold with microwave radiation, and heating the material with the microwave radiation at least until the material is sintered and contracted away from at least one surface of the mold. The method, which may be performed in the vacuum of the Moon, may also include maintaining the temperature of the material while heating the material so that its temperature stays below the melting point of the material. In some implementations, before filling the mold with the material, the material may be sifted so that the material comprises particles having an upper size limit. Smaller particles may be better at absorbing microwave radiation as compared to larger particles.

As mentioned above, the material may be lunar regolith, but could be other material and claimed subject matter is not limited in this respect. For reasons explained below, in some implementations, a microwave susceptor may be added to the material before irradiating the material with the microwave radiation. In these or other implementations, an iron oxide may be added to the material before irradiating the material with the microwave radiation. In the case of lunar regolith, for example, iron oxide is likely present in substantial concentrations. Thus, adding iron oxide may merely be supplementing the already-present concentration of naturally occurring iron oxide. Whether iron oxide is added or not, the method of microwave sintering may also include determining the concentration of iron oxide in the material and, based on the determination, adjusting a length of time for which the material is irradiated with microwave radiation.

In some embodiments, a method of solidifying a material in granular or powdered form, and subsequently releasing the solidified material from a mold may include adding a microwave susceptor to the material, irradiating the material and the microwave susceptor with microwave radiation, and heating the material, via the microwave susceptor, with the microwave radiation at least until the material is sintered and contracted away from at least one surface of the mold to form a molded object. The material may be lunar regolith. As in other embodiments described above, for example, an iron oxide may be added to the material before irradiating the material with the microwave radiation. In some cases, during the heating of the material, the temperature of the material may be maintained below the melting point of the material.

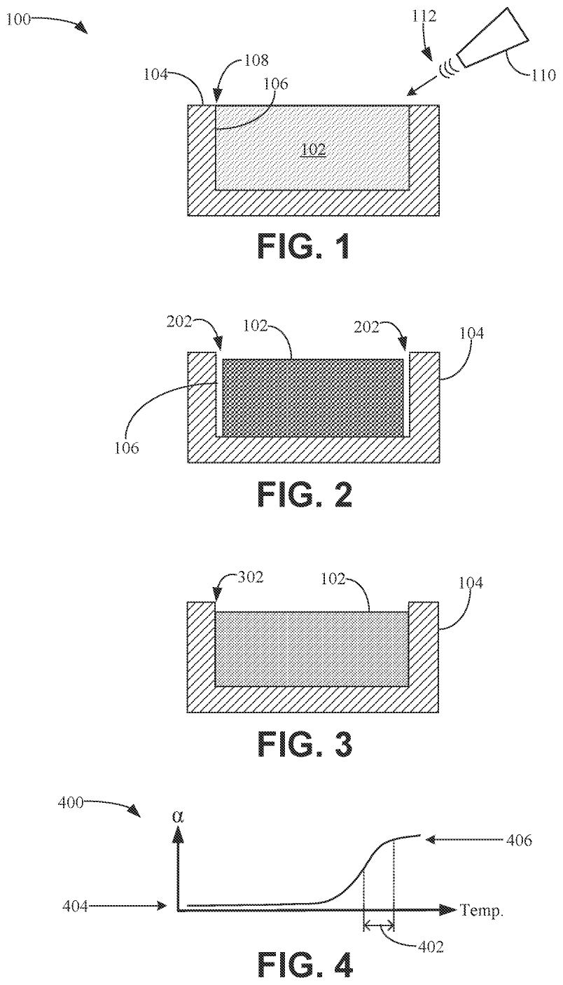

FIG. 1 is a schematic cross-section side view of a system 100 that includes a material 102 in a mold 104 that is prepared for microwave sintering, according to some embodiments. Material 102, which may be in granular or powdered form, may at least partially fill mold 104 so that the material is in contact with sides 106 of the mold. Such contact likely naturally occurs due to settling (e.g., due to gravity) of the material against sides 106. Arrow 108 indicates the contact between material 102 and sides 106. System 100 includes a microwave emitter 110 configured to emit microwave radiation 112 directed to material 102. Mold 104 may be made of alumina or other material that allows for at least fairly uniform heat distribution in material 102 and can withstand high temperatures that are generally involved in sintering.

The microwave radiation may be used to heat material 102 to a sintering temperature, which is necessarily below the melting temperature of the material. As mentioned above, material 102 may be lunar regolith that includes iron oxides. The effectiveness of microwave radiation 112 in heating material 102 may be at least partially dependent on the concentration of iron oxides in the material. In some implementations, described below, iron oxide may be added to material 102 to supplement the concentration of naturally occurring iron oxide in the material so that the effectiveness of microwave radiation in heating the material may be improved. In other implementations, also described below, a microwave susceptor may be added to material 102 so that the effectiveness of microwave radiation in heating the material may be improved. In still other implementations, before filling mold 104 with material 102, the material may be sifted so that the material comprises particles having an upper size limit. Smaller particles may be better at absorbing microwave radiation as compared to larger particles. Accordingly, the effectiveness of microwave radiation in heating the material may be improved if the material has been sifted.

In still other implementations, material 102 may be preheated to a relatively hot temperature (though below the melting point of the material) before being radiated with microwave radiation 112 so that the effectiveness of the microwave radiation in heating the material to an even higher temperature for sintering may be improved. At or above the preheated temperature, material 102 may be able to absorb microwave radiation more easily as compared to absorption at cooler temperatures. Preheating may be achieved using laser or concentrated solar heating or resistance heating (e.g., via external resistance elements). These types of heating generally heat the material from the outside inward (e.g., nonuniformly), whereas microwave heating, performed after the preheating, heats the material more uniformly throughout the mass in mold 104. Heating uniformity is generally desired for uniform sintering.

FIG. 2 is a schematic cross-section side view of material 102 after it has been sintered and contracted in mold 104, according to some embodiments. The sintering and contraction may occur after irradiating material 102 with microwave radiation (e.g., 112) for an extended period of time. In particular, the material is sintered and contracted away from sides 106 of the mold. Arrows 202 indicate gaps created by the contraction of material 102 from sides 106 of mold 104. Among other things, these gaps may allow for relatively easy extraction of sintered material 102 from mold 104 even though the mold may have vertical sides (e.g., no draft angle for mold release). Gaps 202 may also prevent possible chemical reactions (e.g., leading to degradation of the mold) from occurring between sides 106 and material 102.

FIG. 3 is a schematic cross-section side view of material 102 after it has been melted and solidified in mold 104, according to some embodiments. For example, if material 102 is irradiated with microwave radiation for an extended period of time past the point when the material has been sintered (and contracted), as in FIG. 2, the material may heat to its melting temperature. When this occurs, material 102 ceases to be a solid sintered mass and at least partially liquifies to fill gaps 202. Subsequent cooling of the molten mass may result in the solidified material being in contact with sides 106 of mold 104 at the former gaps, indicated by arrow 302, for example. During the heated, molten state of material 102, the contact surfaces between the material and the mold may chemically react. If so, then extraction of material 102 from mold 104 may be difficult or impossible and/or damage to the mold may occur. For at least these reasons, microwave radiation may be applied to material 102 only up to the point of sintering, to achieve the situation depicted in FIG. 2, while maintaining the temperature of the material below its melting temperature to avoid the situation depicted in FIG. 3.

FIG. 4 is a graph 400 of a microwave energy absorption coefficient as a function of temperature for an example material, according to some embodiments. As mentioned above, a method of microwave sintering may include preheating the material above a particular temperature or range of temperatures before irradiating the material with microwave radiation. Preheating may be useful because above these temperatures the material is able to substantially absorb the microwave radiation and below these temperatures the material is not able to substantially absorb the microwave radiation. For example, below a temperature range 402, the microwave energy absorption coefficient 404 may be small or negligible. Thus, the material is not able to effectively absorb microwave energy so as to heat the material. On the other hand, above temperature range 402, the microwave energy absorption coefficient 406 may be substantial. In some particular examples, such as for lunar regolith, temperature range 402 may include about 800 degrees Celsius. Thus, the material is able to effectively absorb microwave energy so as to heat the material to a sintering temperature, for example.

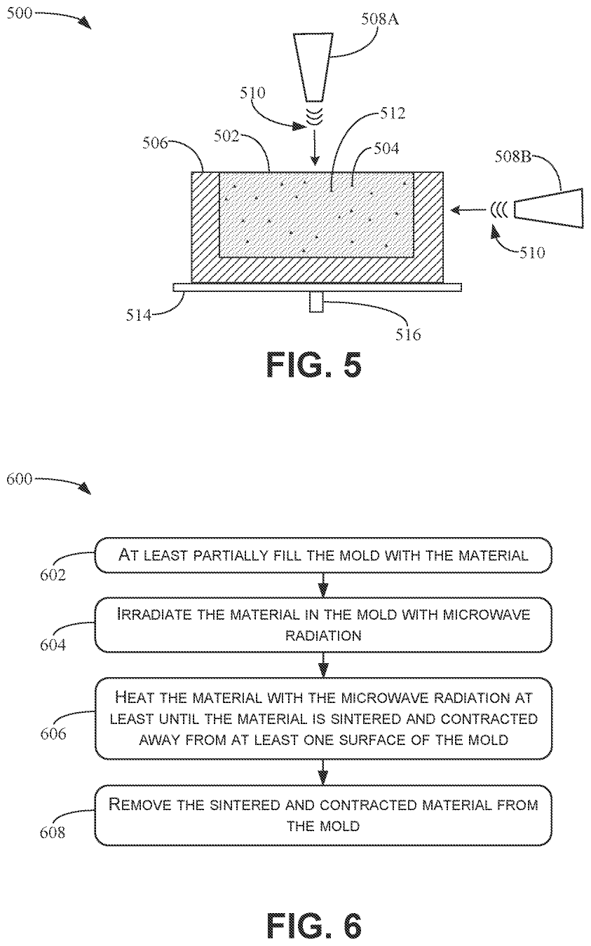

FIG. 5 is a schematic cross-section side view of a system 500 that includes a material 502 with microwave susceptors 504 in a mold 506. System 500 also includes one or more microwave emitters 508A and 508B configured to irradiate material 502 and microwave susceptors 504 with microwave radiation 510 in order to microwave-sinter material 502, according to some embodiments. As mentioned above, microwave susceptors may be added to the material so that the effectiveness of microwave radiation in heating the material may be improved. In some implementations, in addition to microwave susceptors 504, iron oxide 512 may be added to material 502 to supplement the concentration of naturally occurring iron oxide in the material so that the effectiveness of microwave radiation in heating the material may be improved.

In some implementations, one or more walls of mold 506 may be transparent to microwave radiation so that microwave radiation 510 from microwave emitter 508B may transmit through the mold walls and into material 502. In contrast, microwave emitter 508A may be positioned to directly irradiate material 502 from above the material so that microwave radiation need not transmit any part of mold 506 to reach material 502.

In some embodiments, during the heating of the material by microwave radiation, material 502 (and its accompanying microwave susceptors and/or added iron oxide) may be moved by rotating and/or translating the material with respect to the microwave radiation. Such movement may help prevent uneven heating of material 502 due to uneven flux distribution of the microwave radiation. Thus, for example, mold 506 may be disposed on a surface 514 (e.g., a turntable) configured to rotate via shaft 516. On the other hand, in some implementations, microwave emitters 508A and 508B may be configured to move with respect to mold 506.

FIG. 6 is a flow diagram of a process 600 for microwave sintering a material in a mold, according to some embodiments. The process, which may involve material other than lunar regolith, may be performed by an operator, which may be a person or persons, a computer processor executing computer-readable code, or a combination thereof. Process 600 may be performed by the operator using a system that is the same as or similar to any of systems 100 or 500. Accordingly, for the present example, process 600 is described using system 500. Though the following process description involves sintering lunar regolith, other materials, or combinations thereof, may instead be sintered in process 600. Claimed subject matter is not limited in this respect.

At 602, the operator may at least partially fill mold 506 with material 502, which may be lunar regolith. As discussed above, the material may include a microwave susceptor to increase microwave heating efficiency. For example, a microwave susceptor may be added (e.g., mixed in) to the material before irradiating the material with the microwave radiation. Another option for improving the efficiency of microwave heating of the material may be to add iron oxide to the material before irradiating the material with the microwave radiation. Lunar regolith naturally includes iron oxide(s), and its concentration in the regolith may vary depending where on the Moon the regolith was harvested, but adding iron oxide to the already-existing iron oxide may likely enhance the microwave heating efficiency.

At 604, the operator may irradiate material 502 in mold 506 with microwave radiation 510 to heat the material. If microwave susceptors are present in the material, then the microwave radiation heats the microwave susceptors that in turn transfer their heat to the surrounding material 502. During the heating of the material, the operator may maintain the temperature of material 502 below the melting point of the material. For example, if the temperature of the material reaches its melting point, then the physical qualities of a sintered material may be substantially lost if the material melts to a liquid state. Even after the material subsequently cools to a solid, the solid material will not be sintered. This situation is depicted in FIG. 3, wherein the solid material may, among other things, be difficult or impossible to remove from mold 104. For example, the contact between the melted and solidified material and the mold may comprise a chemical bond or reaction that had the opportunity to occur due their mutual contact (at relatively high temperatures). In contrast, avoiding the melting temperature of the material may lead to sintering, at 606, which may likely shrink the material, thus separating the material from walls of the mold (e.g., forming gaps 202). This separation can avoid possible chemical bonding or reactions. Accordingly, at 608, the operator may remove the sintered and contracted (shrunken) material from the mold.

In some implementations, the operator may irradiate material 502 with microwave radiation 510 from microwave emitter 508B that must transmit through walls of form 506. In such implementations, the mold may comprise one or more walls that are transparent to the microwave radiation.

In some embodiments, process 600 may also include the operator determining a concentration of an iron oxide in the material and, based on the determination, adjusting a length of time for which the material is irradiated with the microwave radiation. For example, generally, the higher the iron oxide concentration, the shorter the time needed for irradiating the material to achieve sintering.

In some embodiments, process 600 may also include the operator preheating the material above a particular temperature range before irradiating the material with the microwave radiation. As discussed, above the particular temperature range the material is likely able to substantially absorb the microwave radiation and below the particular temperature range the material may be much less able to substantially absorb the microwave radiation. Thus, preheating may allow for more efficient microwave heating of the material. The preheating may be performed by exposing material 502 to laser or concentrated solar radiation or by heating mold 506 by induction or resistance heating. These heating techniques necessarily do not uniformly heat material 502, and heating uniformity is desired for sintering all of the material in the mold. Accordingly, microwave heating takes over the other types of heating once the preheating stage is finished, for example.

Another way of improving the microwave heating efficiency may be to sift the material so that the material comprises particles having an upper size limit. Generally, the smaller-sized particles may more efficiently absorb microwave radiation. Thus, material 502 may be in a granulated or powdered form.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method of microwave sintering a material in a mold, the method comprising:
at least partially filling the mold with the material;
irradiating the material in the mold with microwave radiation;
heating the material with the microwave radiation at least until the material is sintered and contracted away from at least one surface of the mold; and
removing the sintered and contracted material from the mold.

2. The method of claim 1, wherein the material is lunar regolith.

3. The method of claim 1, wherein the material includes a microwave susceptor.

4. The method of claim 1, further comprising adding a microwave susceptor to the material before irradiating the material with the microwave radiation.

5. The method of claim 1, further comprising adding an iron oxide to the material before irradiating the material with the microwave radiation.

6. The method of claim 1, further comprising, during the heating of the material, maintaining the temperature of the material below the melting point of the material.

7. The method of claim 1, wherein the mold comprises one or more walls that are transparent to the microwave radiation.

8. The method of claim 1, further comprising, during the heating of the material, moving the material by rotating and/or translating the material with respect to the microwave radiation.

9. The method of claim 1, further comprising:
determining a concentration of an iron oxide in the material; and
based on the determination, adjusting a length of time for which the material is irradiated with the microwave radiation.

10. The method of claim 1, further comprising preheating the material above a particular temperature range before irradiating the material with the microwave radiation, wherein above the particular temperature range the material is able to substantially absorb the microwave radiation and below the particular temperature range the material is not able to substantially absorb the microwave radiation.

11. The method of claim 1, further comprising, before at least partially filling the mold with the material, sifting the material so that the material comprises particles having an upper size limit.

12. A method of solidifying a granular or powdered material and subsequently releasing the solidified granular or powdered material from a mold, the method comprising:
adding a microwave susceptor to the granular or powdered material;
irradiating the granular or powdered material and the microwave susceptor with microwave radiation;
heating the granular or powdered material, via the microwave susceptor, with the microwave radiation at least until the granular or powdered material is sintered and contracted away from at least one surface of the mold to form a molded object; and
removing the molded object from the mold.

13. The method of claim 12, wherein the granular or powdered material is lunar regolith.

14. The method of claim 12, further comprising adding an iron oxide to the granular or powdered material before irradiating the granular or powdered material with the microwave radiation.

15. The method of claim 12, further comprising, during the heating of the granular or powdered material, maintaining the temperature of the granular or powdered material below the melting point of the granular or powdered material.

16. The method of claim 12, wherein the mold comprises one or more walls that are transparent to the microwave radiation.

17. The method of claim 12, further comprising, during the heating of the granular or powdered material, moving the granular or powdered material by rotating and/or translating the granular or powdered material with respect to the microwave radiation.

18. The method of claim 12, further comprising:
determining a concentration of an iron oxide in the granular or powdered material; and
based on the determination, adjusting a length of time for which the granular or powdered material is irradiated with the microwave radiation.

19. The method of claim 12, wherein the method is performed in the vacuum of the Moon.

20. The method of claim 12, further comprising, before at least partially filling the mold with the granular or powdered material, sifting the granular or powdered material so that the granular or powdered material comprises particles having an upper size limit.
